(19) United States
(12) Patent Application Publication
(10) Pub. No.: US 2026/0264406 A1
(43) Pub. Date: Sep. 10, 2026

(54) INKJET RECORDING APPARATUS

(71) Applicant: KYOCERA Document Solutions Inc., Osaka (JP)

(72) Inventors: Naozumi OGAWA, Osaka (JP); Masakazu UEHARA, Osaka (JP); Hiroaki OHASHI, Osaka (JP); Daisuke MIMURA, Osaka (JP)

(73) Assignee: KYOCERA Document Solutions Inc., Osaka (JP)

(21) Appl. No.: 19/556,228

(22) Filed: Mar. 4, 2026

(30) Foreign Application Priority Data
Mar. 7, 2025 (JP) 2025-036427

(51) Int. Cl. B41J 2/165

(52) U.S. Cl. CPC B41J 2/16511; B41P 2235/20

(57) ABSTRACT

An inkjet recording apparatus includes a recording head and a maintenance unit. A guide member of the maintenance unit is supported to the maintenance unit so as to be reciprocatable from a maintenance surface of the maintenance unit in a normal direction thereof toward and away from an ink ejection surface of the recording head and contacts the recording head during a maintenance process.

### INCORPORATION BY REFERENCE

This application is based upon and claims the benefit of priority from the corresponding Japanese Patent Application No. 2025-036427 (filed on Mar. 7, 2025), the entire contents of which are hereby incorporated by reference.

### BACKGROUND

The present disclosure relates to an inkjet recording apparatus.

Inkjet recording apparatuses, which record images by ejecting ink onto recording media such as sheets, are capable of recording high-definition images and thus have been widely used as recording apparatuses such as printers and copy machines. Furthermore, nowadays, the inkjet recording apparatuses are requested to achieve a size reduction and space saving, and from this viewpoint, in some such apparatuses, each recording head is arranged to be inclined with respect to a horizontal direction so that ink is ejected therefrom at an angle inclined from vertical toward horizontal.

Furthermore, in the inkjet recording apparatuses, residual ink remaining on an ink ejection surface of any recording head might be solidified to cause an ejection failure. To suppress such solidification of ink on the ink ejection surface or to remove solidified ink therefrom, there are known conventional techniques for maintenance of the ink ejection surface, such as capping, wiping, and flushing.

### SUMMARY

An inkjet recording apparatus according to one aspect of the present disclosure includes a conveyance portion, a recording head, a maintenance unit, a first movement mechanism, and a second movement mechanism. The conveyance portion conveys a recording medium. The recording head has an ink ejection surface in which a nozzle for ejecting ink onto the recording medium is open and that is arranged parallel and opposite to a conveyance surface of the conveyance portion. The maintenance unit performs a maintenance process with respect to the ink ejection surface of the recording head. The first movement mechanism moves the recording head so that the recording head is selectively arranged either at a recording position close to the conveyance portion or at a maintenance position distant from the recording position. The second movement mechanism moves the maintenance unit so that the maintenance unit is selectively arranged either at an insertion position between the conveyance surface and the ink ejection surface or at a retracted position retracted from the insertion position. The maintenance unit includes a maintenance surface, a guide member, and a third movement mechanism. The maintenance surface is arranged parallel and opposite to the ink ejection surface of the recording head and performs the maintenance process with respect to the ink ejection surface. The guide member is supported to the maintenance unit so as to be reciprocatable from the maintenance surface in a normal direction thereof toward and away from the ink ejection surface and contacts the recording head during the maintenance process. The third movement mechanism moves the guide member in the normal direction of the maintenance surface so that the guide member is selectively arranged either at a protruding position at which the guide member protrudes from the maintenance surface or at a housing position at which the guide member is housed in the maintenance unit.

### BRIEF DESCRIPTION OF THE DRAWINGS

FIG. 1 is a schematic sectional side view of an inkjet recording apparatus according to one embodiment of the present disclosure.

FIG. 2 is a perspective view of a recording portion of the inkjet recording apparatus shown in FIG. 1.

FIG. 3 is a perspective view of a maintenance unit of the inkjet recording apparatus shown in FIG. 1.

FIG. 4 is a perspective view of the maintenance unit shown in FIG. 3, illustrating a state where guide members are arranged at a protruding position.

FIG. 5 is a side view of and around the recording portion and the maintenance unit of the inkjet recording apparatus shown in FIG. 1.

FIG. 6 is a side view of the recording portion shown in FIG. 2 and the maintenance unit, illustrating a capped state of an ink ejection surface.

FIG. 7 is a side view of the recording portion shown in FIG. 2 and the maintenance unit, illustrating a start position for starting a wiping process with respect to the ink ejection surface.

FIG. 8 is a partially enlarged side view of the recording portion and the maintenance unit shown in FIG. 7.

FIG. 9 is a side view of the recording portion and the maintenance unit shown in FIG. 7, illustrating an end position for ending the wiping process with respect to the ink ejection surface.

FIG. 10 is a sectional side view of the maintenance unit shown in FIG. 3, illustrating a state where the guide members are arranged at a housing position.

FIG. 11 is a sectional side view of the maintenance unit shown in FIG. 3, illustrating a state where the guide members are arranged at the protruding position.

FIG. 12 is a side view of the recording portion shown in FIG. 2 and the maintenance unit, illustrating a state of flushing of a recording head group.

### DETAILED DESCRIPTION

With reference to the appended drawings, the following describes an embodiment of the present disclosure. The present disclosure, however, is not limited to what is described below.

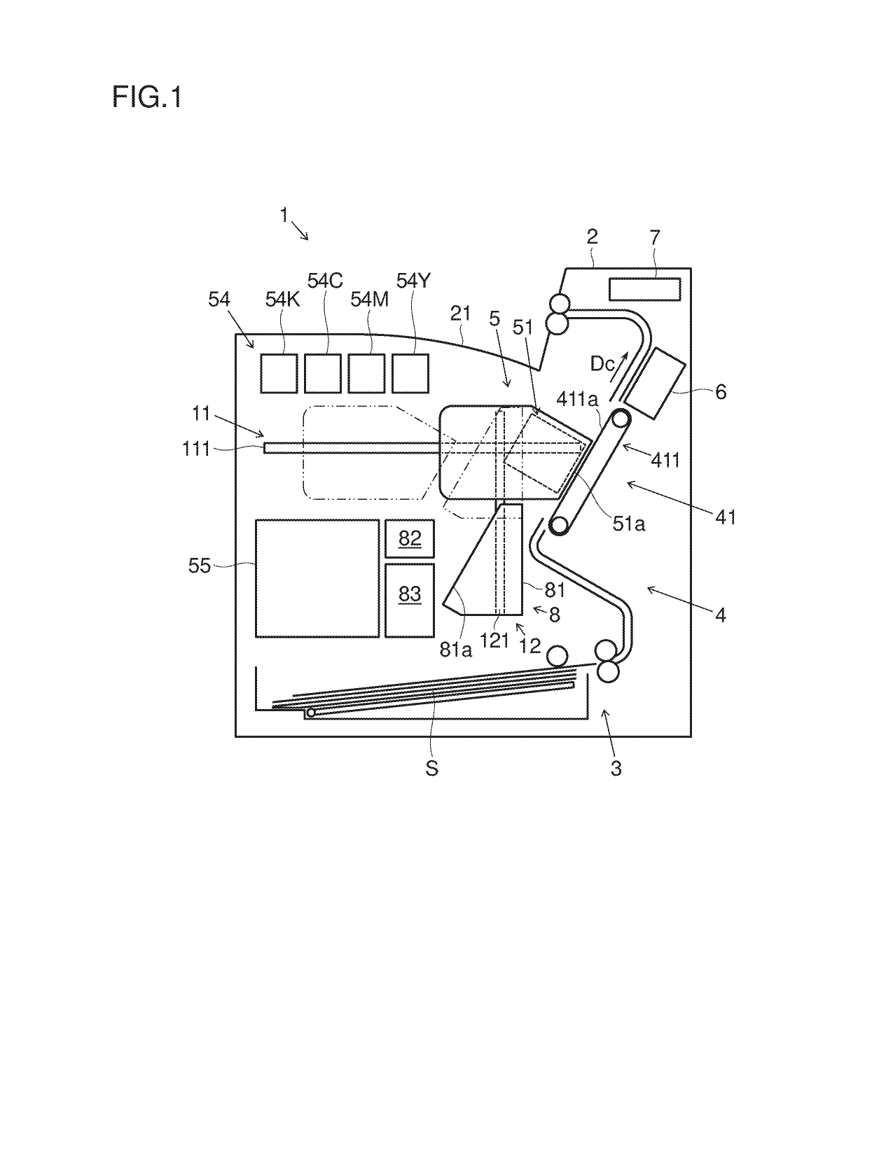

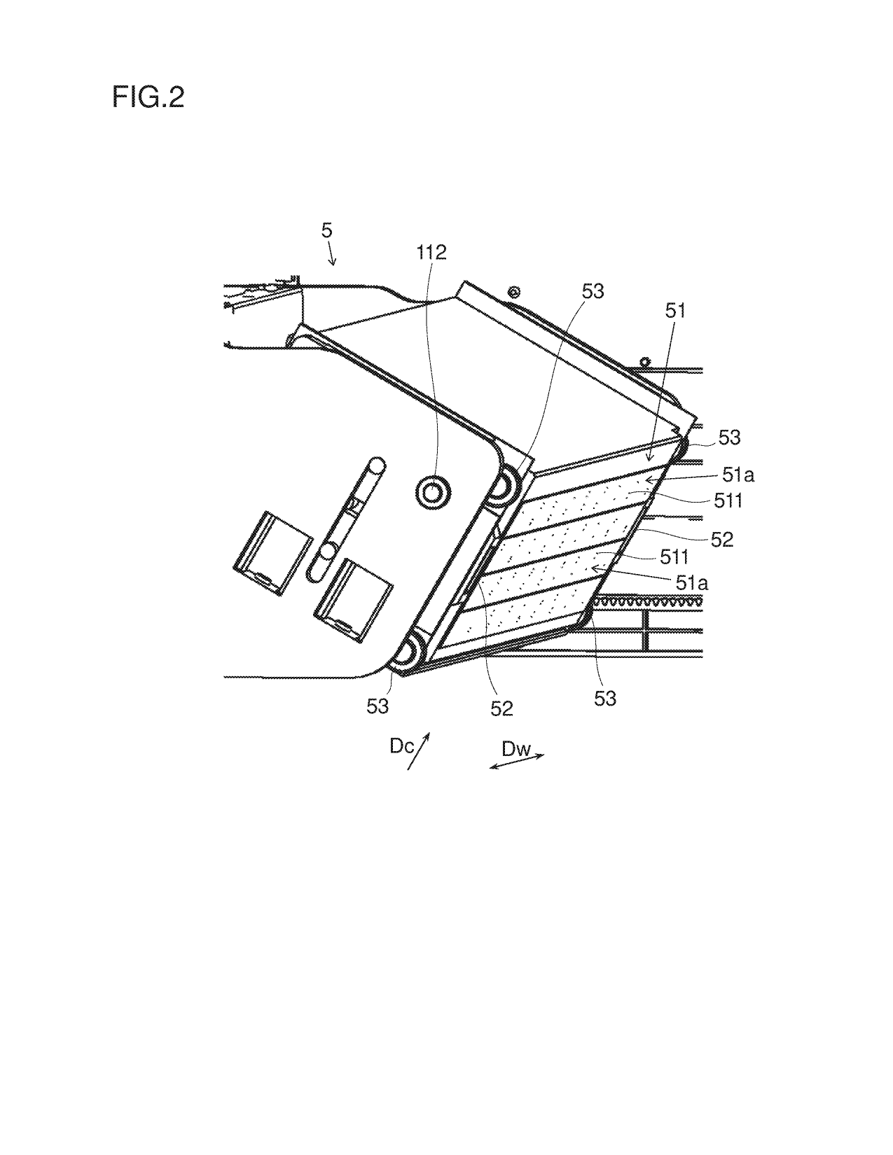

FIG. 1 is a schematic sectional side view of an inkjet recording apparatus 1 according to the embodiment. FIG. 2 is a perspective view of a recording portion 5 of the inkjet recording apparatus 1 shown in FIG. 1. The inkjet recording apparatus 1 is, for example, an inkjet recording type printer. As shown in FIG. 1, the inkjet recording apparatus 1 includes an apparatus main body 2, a sheet feed portion 3, a sheet conveyance portion (conveyance portion) 4, the recording portion 5, a drying portion 6, and a control portion 7.

The sheet feed portion 3 is arranged in, for example, a lower part of the apparatus main body 2. The sheet feed portion 3 houses a plurality of sheets (recording media) S and feeds them out one by one separately during recording.

The sheet conveyance portion 4 is arranged downstream of the sheet feed portion 3 in a sheet conveyance direction and above the sheet feed portion 3. The sheet conveyance portion 4 conveys the sheet S fed out from the sheet feed portion 3. The sheet conveyance portion 4 conveys the sheet S to the recording portion 5 and to the drying portion 6 and further discharges the sheet S after being subjected to recording and drying to a sheet discharge portion 21.

The sheet conveyance portion 4 includes a belt conveyance part 41. The belt conveyance part 41 includes a conveyance belt 411 formed to be endless. The conveyance belt 411 is so arranged that a conveyance surface 411a thereof for conveying the sheet S is inclined with respect to a horizontal direction. In this embodiment, the conveyance belt 411 is inclined, for example, at an angle of 60 degrees with respect to the horizontal direction. Furthermore, the conveyance belt 411 is arranged opposite to the recording portion 5. In a region of an outer circumferential surface of the conveyance belt 411 opposite to the recording portion 5, the belt conveyance part 41 conveys the sheet S while holding it by suction.

The recording portion 5 includes a recording head group 51 (which may be referred to also as recording heads 51). The recording head group 51 is positioned downstream of the sheet feed portion 3 in the sheet conveyance direction and is arranged opposite to the belt conveyance part 41. The recording head group 51 includes an ink ejection surface 51a. The ink ejection surface 51a is arranged parallel and opposite to the conveyance surface 411a of the conveyance belt 411. Since the conveyance surface 411a of the conveyance belt 411 is inclined with respect to the horizontal direction, the ink ejection surface 51a is arranged to be inclined with respect to the horizontal direction (for example, at an inclination angle of 60 degrees). A multitude of ink ejection nozzles 511 are open and arrayed in the ink ejection surface 51a.

As shown in FIG. 2, the recording head group 51 includes a pair of positioning holes 52 and two pairs of positioning members 53.

At a middle of the recording heads 51 of four different colors in a sheet conveyance direction Dc and on outer sides of both ends of the ink ejection surface 51a in a sheet width direction Dw (a depth direction of a drawing plane of FIG. 1) orthogonal to the sheet conveyance direction Dc, the pair of positioning holes 52 is arranged opposite to the conveyance surface 411a of the conveyance belt 411. The positioning holes 52 are each formed of a concave recessed from the ink ejection surface 51a toward an inner side of the recording head group 51 in a direction away from the conveyance surface 411a.

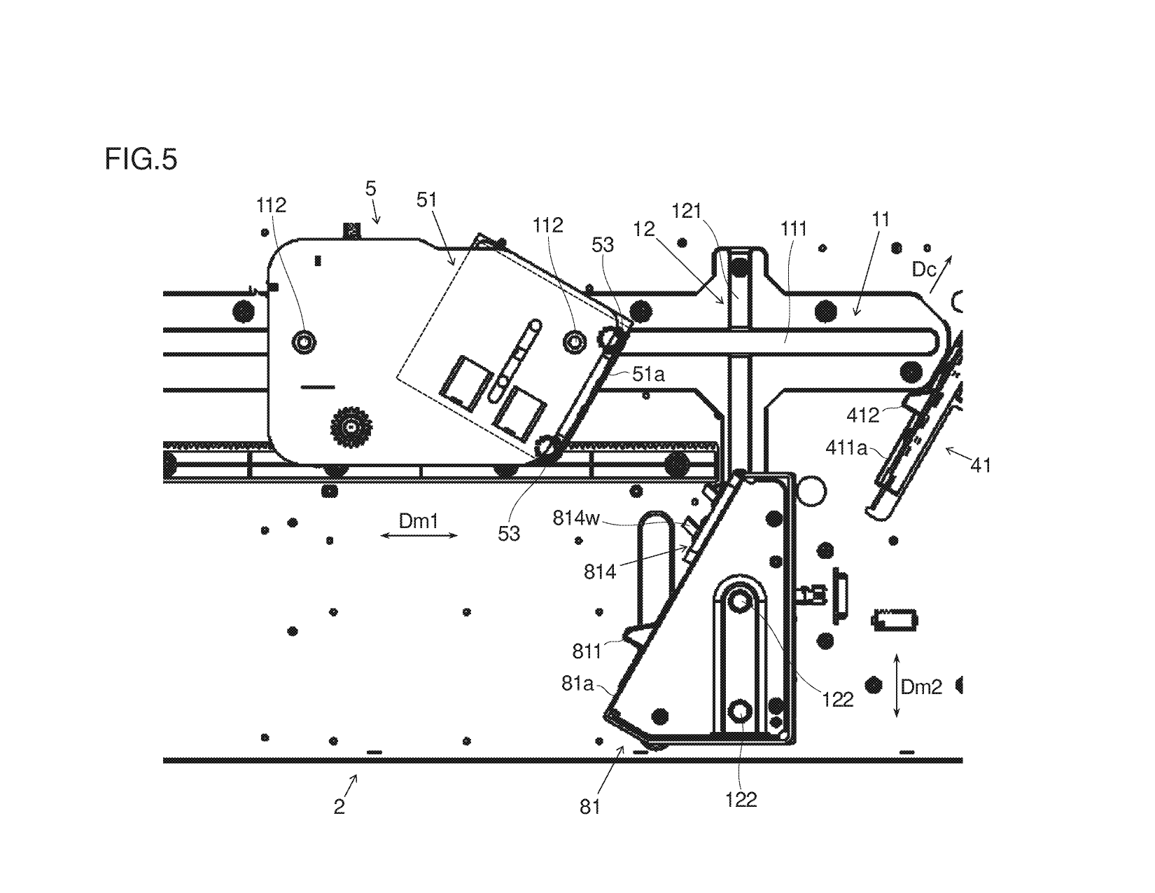

With respect to the pair of positioning holes 52, the belt conveyance part 41 includes a pair of positioning pieces 412 (see FIG. 5). On outer sides of both ends of the conveyance belt 411 in the sheet width direction Dw, the pair of positioning pieces 412 is arranged opposite to the ink ejection surface 51a of the recording head group 51. The positioning pieces 412 are each a wedge-shaped or triangular member formed to protrude for a prescribed distance from the conveyance surface 411a of the conveyance belt 411 toward the ink ejection surface 51a. The pair of positioning pieces 412 is inserted into the pair of positioning holes 52 formed in the recording head group 51.

The two pairs of positioning members 53 are arranged on outer sides of the pair of positioning holes 52 in the sheet width direction Dw. The two pairs of positioning members 53 are provided outside an ejection region on the ink ejection surface 51a and at both the ends of the ink ejection surface 51a in the sheet width direction Dw and are arranged opposite to the conveyance surface 411a of the conveyance belt 411. The pairs of positioning members 53 are each juxtaposed in the sheet conveyance direction Dc along the ink ejection surface 51a.

Each of the positioning members 53 is an arc-shaped or disc-shaped member arranged to protrude for a prescribed distance from the ink ejection surface 51a toward the conveyance surface 411a. Outer circumferential surfaces of the positioning members 53 contact outsides of a conveyance region of the sheet S on the conveyance surface 411a (both ends of the conveyance surface 411a in the sheet width direction Dw). Thus, the ink ejection surface 51a is opposed to the sheet S being conveyed while being held by suction to the conveyance surface 411a of the conveyance belt 411 and is arranged at a prescribed spacing from the conveyance belt 411.

In this embodiment, as shown in FIG. 2, the recording portion 5 includes the recording heads 51 corresponding to four colors of black, cyan, magenta, and yellow, respectively. The recording heads 51 of the four colors are juxtaposed along the sheet conveyance direction Dc so that a longitudinal direction thereof is parallel to the sheet width direction Dw. The recording heads 51 of the four colors are each individually supplied with ink of a corresponding one of the four colors stored in ink containers 54 provided outside the recording portion 5.

Furthermore, the inkjet recording apparatus 1 includes the ink containers 54 and an ink supply system 55. The ink containers 54 include ink containers 54K, 54C, 54M, and 54Y corresponding to the four colors of black, cyan, magenta, and yellow, respectively. The ink containers 54K, 54C, 54M, and 54Y store the ink of the respective colors of black, cyan, magenta, and yellow.

The ink supply system 55 is composed of an ink supply path, a pump, an open/close valve, a check valve, and so on (none of which is shown). Based on a control signal from the control portion 7, the ink supply system 55 individually supplies the ink of the four colors (black, cyan, magenta, and yellow) stored respectively in the ink containers 54K, 54C, 54M, and 54Y to the recording heads 51 corresponding to the respective colors. The recording portion 5 sequentially ejects the ink through the recording heads 51 of the four colors toward the sheet S being conveyed by the conveyance belt 411 so that a full-color image or a monochrome image is recorded on the sheet S.

The drying portion 6 is arranged downstream of the recording portion 5 in the sheet conveyance direction and above the recording portion 5. In the drying portion 6, the ink on the sheet S on which an ink image has been recorded in the recording portion 5 is dried while the sheet S is conveyed by the sheet conveyance portion 4. The sheet S on which image recording and drying have thus been performed to complete printing is discharged to the sheet discharge portion 21 provided on an upper surface of the apparatus main body 2.

The control portion 7 includes a CPU, an image processing part, a storage part, and other electronic circuits and electronic components (none of which is shown). Based on control programs or data stored in the storage part, the CPU controls operations of various constituent elements provided in the inkjet recording apparatus 1 so as to perform processes related to functions of the inkjet recording apparatus 1. The sheet feed portion 3, the sheet conveyance portion 4, the recording portion 5, and the drying portion 6 individually receive, from the control portion 7, instructions to perform recording on the sheet S in collaboration with each other. The storage part is formed of a combination of, for example, a nonvolatile storage device such as a program ROM (read-only memory) or a data ROM and a volatile storage device such as a RAM (random-access memory).

Furthermore, the inkjet recording apparatus 1 includes a maintenance portion 8. The maintenance portion 8 includes a maintenance unit 81, a suction pump 82, and a waste ink tank 83.

The maintenance unit 81 is mountable to and demountable from the ink ejection surface 51a of the recording head group 51. The maintenance unit 81 performs a maintenance process with respect to the ink ejection surface 51a of the recording head group 51. In a case of not performing the maintenance process with respect to the recording head group 51, the maintenance unit 81 is arranged at a retracted position with respect to the recording head group 51, which is a position retracted to below the recording head group 51 as shown in FIG. 1.

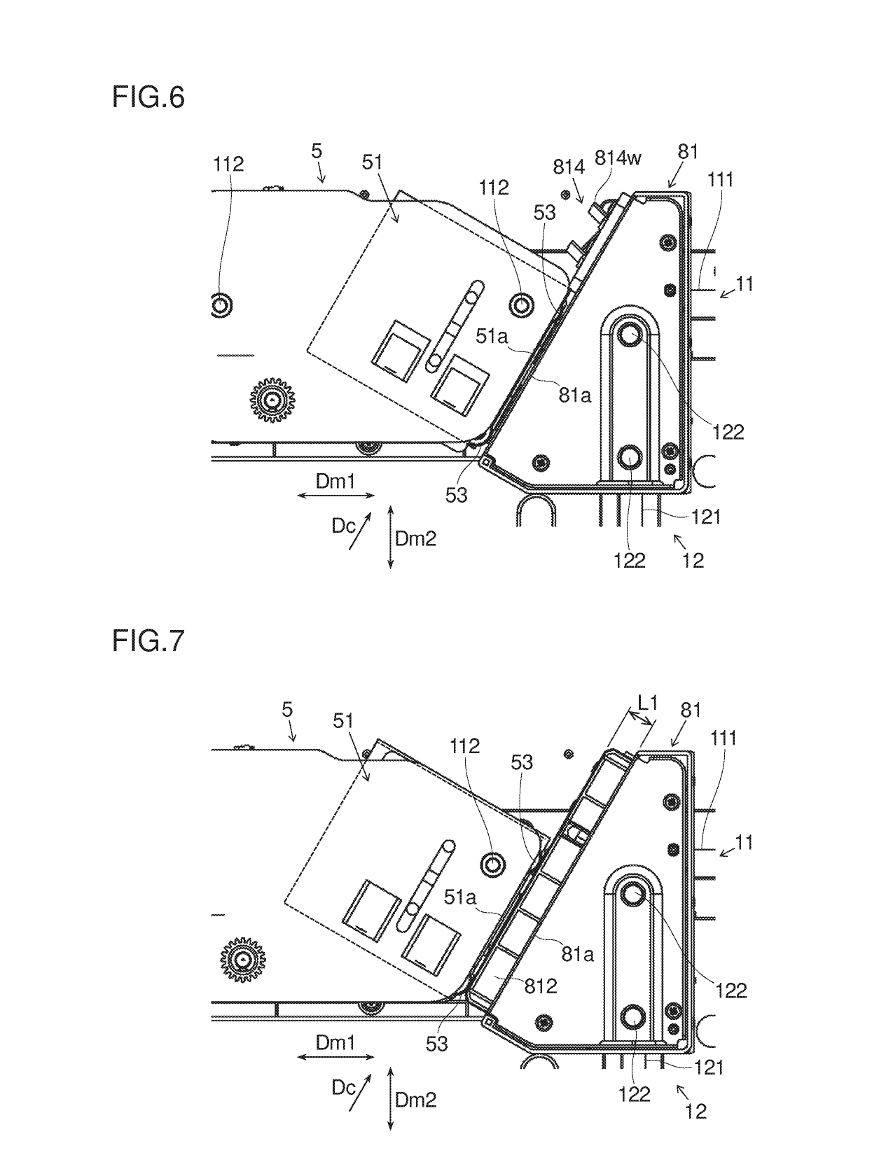

In the inkjet recording apparatus 1, the maintenance process with respect to the recording head group 51 is executed at a previously set timing. The maintenance process with respect to the recording head group 51 is executed, for example, at a start of recording after an extended period of non-operation or during a time interval between recording operations. In a case of executing the maintenance process with respect to the recording head group 51, the control portion 7 performs control so that an after-mentioned movement mechanism moves the maintenance unit 81 to an insertion position (a position indicated by a chain double-dashed line in FIG. 1, see FIGS. 6, 7, and 12) between the conveyance surface 411a of the conveyance belt 411 and the ink ejection surface 51a of the recording head group 51.

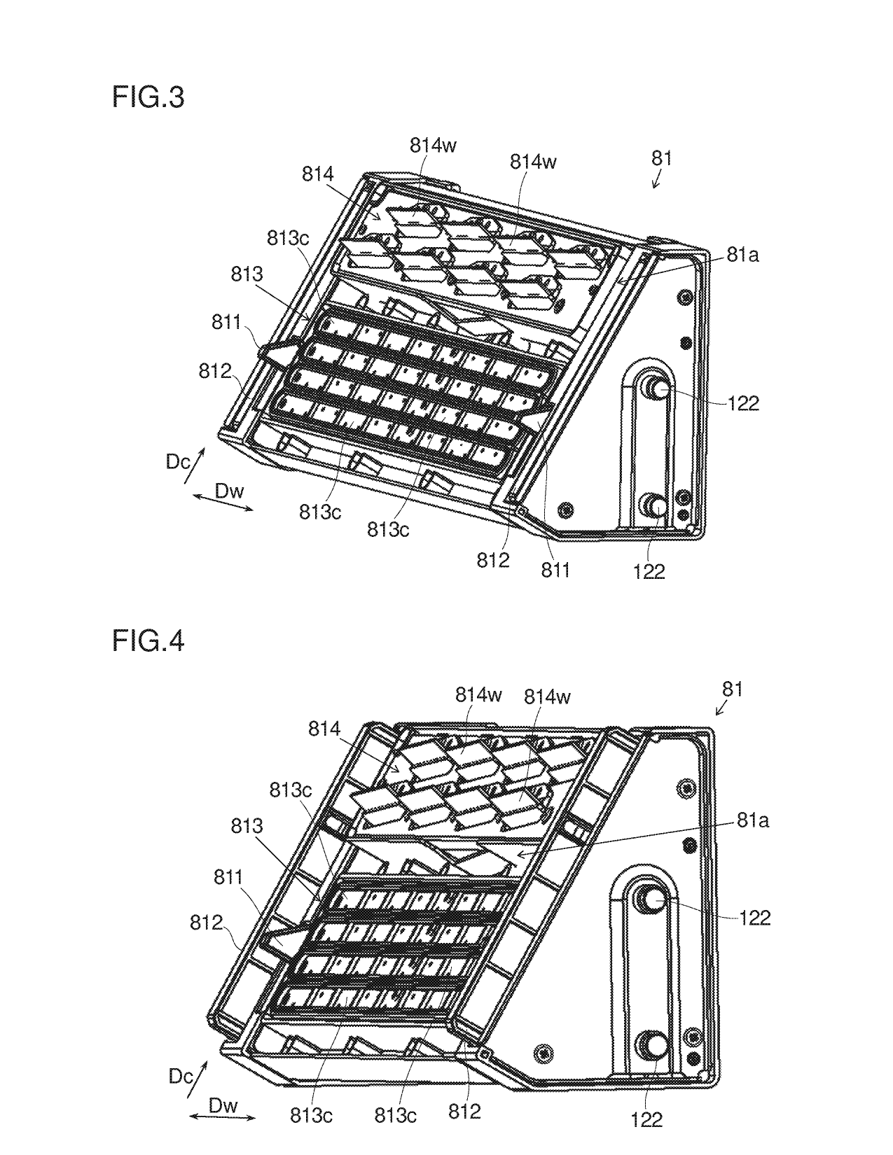

FIG. 3 is a perspective view of the maintenance unit 81 of the inkjet recording apparatus 1 shown in FIG. 1. FIG. 4 is a perspective view of the maintenance unit 81 shown in FIG. 3, illustrating a state where guide members 812 are arranged at a protruding position. During the maintenance process with respect to the recording head group 51, the maintenance unit 81 is arranged opposite to the recording head group 51. The maintenance unit 81 includes a maintenance surface 81a, a pair of positioning pieces 811, and a pair of guide members 812.

The maintenance surface 81a is arranged parallel and opposite to the ink ejection surface 51a of the recording head group 51. Since the ink ejection surface 51a is inclined with respect to the horizontal direction, the maintenance surface 81a is inclined with respect to the horizontal direction. The maintenance surface 81a performs the maintenance process with respect to the ink ejection surface 51a.

In the maintenance unit 81, a capping section 813 and a wiping section 814 are provided on the maintenance surface 81a.

At a start of recording after an extended period of non-operation or during a time interval between recording operations, the capping section 813 is mounted to the ink ejection surface 51a so as to suppress drying of the ink ejection surface 51a of the recording head group 51 and drying inside the nozzles 511 therein and to remove thickened ink, solidified ink, foreign matter, and so on. The capping section 813 includes capping members 813c formed in concave shapes to cover the ink ejection surface 51a.

The capping members 813c are mountable to and demountable from the ink ejection surface 51a. When the capping section 813 is arranged at a mounting position at which the capping section 813 covers the ink ejection surface 51a, an enclosed space is formed between the ink ejection surface 51a and the capping members 813c. In the maintenance process using the capping section 813, for example, a suction purging process is executed in which the suction pump 82 sucks air in the enclosed space between the ink ejection surface 51a and the capping section 813 so that the ink is forcibly sucked out from all the nozzles 511 of the recording head group 51.

Furthermore, the recording head group 51 performs a flushing (idle ejection) process in which the ink is periodically ejected through the nozzles 511 so as to reduce and prevent clogging of the nozzles 511 caused by dried ink. In the flushing process, for example, at a timing different from a timing for ejecting the ink to the sheet S (during image recording), i.e., during a non-image recording period when the ink is not ejected onto the sheet S, the ink is ejected in the shape of a line extending in the sheet width direction Dw.

At a start of recording after an extended period of non-operation or during a time interval between recording operations, the wiping section 814 performs a wiping process with respect to the ink ejection surface 51a so as to remove thickened ink, solidified ink, foreign matter, and so on adhering to the ink ejection surface 51a of the recording head group 51. The wiping section 814 includes wipers 814w for contacting the ink ejection surface 51a and wiping off the ink, foreign matter, and so on therefrom.

The wipers 814w are made of a rubber such as, for example, EPDM (ethylene propylene diene rubber) and are each an elastic member formed in a plate shape. The wiping section 814 includes a plurality of wipers 814w juxtaposed in the sheet conveyance direction Dc and in the sheet width direction Dw. In this embodiment, as shown in FIG. 3, the wiping section 814 includes two rows (in the sheet conveyance direction Dc) of four wipers 814w (in the sheet width direction Dw), namely, eight wipers 814w in total. In a state of being inclined with respect to the sheet width direction Dw, the eight wipers 814w are mounted to the maintenance surface 81a.

When the maintenance surface 81a is brought close to the ink ejection surface 51a, the wipers 814w contact the ink ejection surface 51a under a prescribed pressure. As the maintenance unit 81 moves relative to the recording head group 51, the wipers 814w move along the ink ejection surface 51a in the sheet conveyance direction Dc so as to wipe off residues such as the ink from the ink ejection surface 51a. The wipers 814w are inclined with respect to the sheet width direction Dw and thus can smoothly move on the ink ejection surface 51a so as to thoroughly wipe off residues from the ink ejection surface 51a.

The ink (purged ink) sucked out from the nozzles 511 into the capping section 813, the ink ejected through the nozzles 511 during the flushing process, and residues such as the ink wiped off from the ink ejection surface 51a during the wiping process are discharged to an exterior of the maintenance unit 81 by the suction pump 82 and then are collected in the waste ink tank 83 via a waste ink collection flow path (not shown).

On outer sides of both ends of the capping section 813 in the sheet width direction Dw, the pair of positioning pieces 811 is arranged opposite to the ink ejection surface 51a of the recording head group 51. The positioning pieces 811 are each a wedge-shaped or triangular member formed to protrude for a prescribed distance from the maintenance surface 81a toward the ink ejection surface 51a. In a case where the maintenance surface 81a is brought close to the ink ejection surface 51a in the maintenance process by the maintenance unit 81, the pair of positioning pieces 811 is inserted into the pair of positioning holes 52 (see FIG. 2) formed in the recording head group 51.

At both ends of the maintenance unit 81 in the sheet width direction Dw and on outer sides of the maintenance surface 81a and the positioning pieces 811, the guide members 812 are arranged opposite to the ink ejection surface 51a of the recording head group 51. The guide members 812 are supported to the maintenance unit 81 so as to be reciprocatable from the maintenance surface 81a in a normal direction thereof toward and away from the ink ejection surface 51a. During the maintenance process, the guide members 812 contact the recording head group 51.

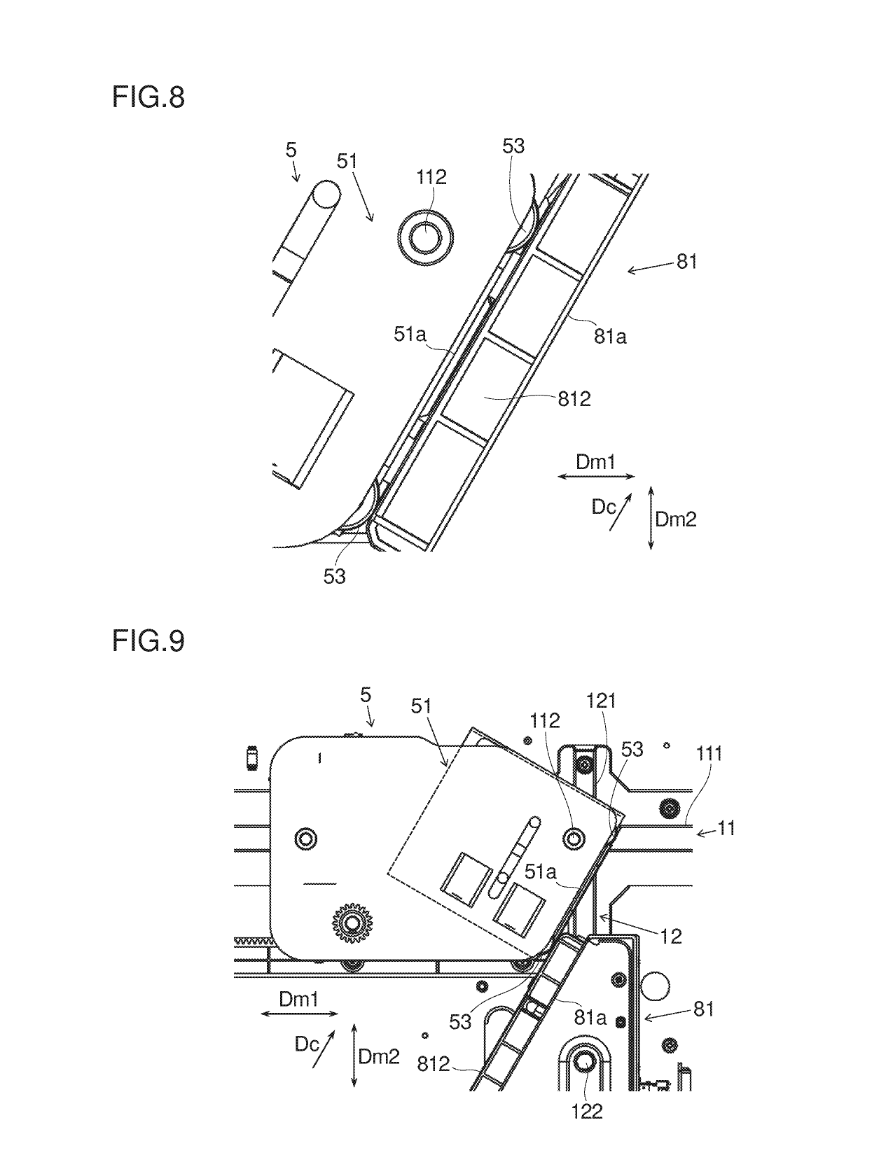

Next, a description is given of movement mechanisms for the recording portion 5 and the maintenance unit 81, respectively. FIG. 5 is a side view of and around the recording portion 5 and the maintenance unit 81 of the inkjet recording apparatus 1 shown in FIG. 1. FIGS. 6 and 7 are side views of the recording portion 5 shown in FIG. 2 and the maintenance unit 81, illustrating a capped state of the ink ejection surface 51a and a start position for starting the wiping process with respect to the ink ejection surface 51a, respectively. FIG. 8 is a partially enlarged side view of the recording portion 5 and the maintenance unit 81 shown in FIG. 7. FIG. 9 is a side view of the recording portion 5 and the maintenance unit 81 shown in FIG. 7, illustrating an end position for ending the wiping process with respect to the ink ejection surface 51a.

With regard to movements of the recording portion 5 and the maintenance unit 81, the inkjet recording apparatus 1 includes a first movement mechanism 11, a second movement mechanism 12, and a third movement mechanism 13.

Relative to the apparatus main body 2, the first movement mechanism 11 moves the recording portion 5 (the recording head group 51) in a first movement direction Dm1, which is the horizontal direction. The first movement mechanism 11 includes a pair of first guide rails 111, two pairs of first guide pins 112, and a first drive part (not shown). While in this embodiment, the first movement mechanism 11 includes a single combination of the pair of first guide rails 111 and the two pairs of first guide pins 112, the first movement mechanism 11 may include two or more combinations thereof.

The pair of first guide rails 111 is secured to inner surfaces of side walls of the apparatus main body 2. On outer sides of one and the other ends of the recording portion 5 in a sheet width direction (a depth direction of a drawing plane of each of FIGS. 5, 6, and 7), the pair of first guide rails 111 is arranged opposite to the recording portion 5 in the sheet width direction. The first guide rails 111 extend in a direction toward or away from the belt conveyance part 41, which is the horizontal direction.

The two pairs of first guide pins 112 are secured to outer surfaces of side walls of the recording portion 5. The two pairs of first guide pins 112 are provided on side surfaces of the recording head group 51 at one and the other ends thereof in the sheet width direction and protrude outward in the sheet width direction. Each of the two pairs of first guide pins 112 includes first guide pins 112 juxtaposed in the horizontal direction along a corresponding one of the first guide rails 111 arranged opposite to each other in the sheet width direction. The first guide pins 112 are supported to the first guide rails 111 so as to be horizontally reciprocatable along the first guide rails 111 arranged opposite to each other in the sheet width direction.

The first drive part includes a drive source such as a motor and a drive mechanism such as a group of gears or a wire and a pulley (none of which is shown). The motor is connected to the recording portion 5 via the drive mechanism. Upon the motor being driven, the first movement mechanism 11 moves the recording portion 5 in the horizontal direction along the first guide rails 111. Specifically, the first movement mechanism 11 moves the recording head group 51 so that the recording head group 51 is selectively arranged either at a recording position (see FIG. 1) close to the belt conveyance part 41 or at a maintenance position (see FIGS. 5, 6, and 7) distant from the recording position.

According to the above-described configuration, when the recording head group 51 is moved from the recording position to be arranged at the maintenance position, the recording head group 51 is moved in the horizontal direction, and thus the inkjet recording apparatus 1 can be configured not to be increased in height more than necessary. Accordingly, it is possible to suppress a size increase of the inkjet recording apparatus 1 in a height direction. Thus, an operation portion of the inkjet recording apparatus 1 can be arranged at a favorable height, and this makes it possible to improve operability for a user. Furthermore, a sufficient space for housing the sheets S can be allocated in a lower part of the inkjet recording apparatus 1, and this makes it possible to improve convenience of the inkjet recording apparatus 1.

Relative to the apparatus main body 2, the second movement mechanism 12 moves the maintenance unit 81 in a second movement direction Dm2, which is a perpendicular direction. The second movement direction Dm2 is orthogonal to the first movement direction Dm1. The second movement mechanism 12 includes a pair of second guide rails 121, two pairs of second guide pins 122, and a second drive part (not shown). While in this embodiment, the second movement mechanism 12 includes a single combination of the pair of second guide rails 121 and the two pairs of second guide pins 122, the second movement mechanism 12 may include two or more combinations thereof.

The pair of second guide rails 121 is secured to the inner surfaces of the side walls of the apparatus main body 2. On outer sides of one and the other ends of the maintenance unit 81 in the sheet width direction, the pair of second guide rails 121 is arranged opposite to the maintenance unit 81 in the sheet width direction. The second guide rails 121 extend in a direction toward or away from the recording portion 5 that moves along the first guide rails 111, which is the perpendicular direction.

The two pairs of second guide pins 122 are secured to outer surfaces of side walls of the maintenance unit 81. The two pairs of second guide pins 122 are provided on side surfaces of the maintenance unit 81 at the one and the other ends thereof in the sheet width direction and protrude outward in the sheet width direction. Each of the two pairs of second guide pins 122 includes second guide pins 122 juxtaposed in a top-bottom direction along a corresponding one of the second guide rails 121 arranged opposite to each other in the sheet width direction. The second guide pins 122 are supported to the second guide rails 121 so as to be reciprocatable up and down along the second guide rails 121 arranged opposite to each other in the sheet width direction.

The second drive part includes a drive source such as a motor and a drive mechanism such as a group of gears or a wire and a pulley (none of which is shown). The motor is connected to the maintenance unit 81 via the drive mechanism. Upon the motor being driven, the second movement mechanism 12 moves the maintenance unit 81 in the top-bottom direction along the second guide rails 121. Specifically, the second movement mechanism 12 moves the maintenance unit 81 so that the maintenance unit 81 is selectively arranged either at an insertion position (see FIGS. 6 and 7) between the conveyance surface 411a and the ink ejection surface 51a or at a retracted position (see FIGS. 1 and 5) retracted from the insertion position.

By the second movement mechanism 12, the maintenance unit 81 is retracted to the retracted position below the recording portion 5. According to this configuration, it is possible to suppress a situation where moving the maintenance unit 81 to the retracted position requires the inkjet recording apparatus 1 to be increased in height more than necessary. Accordingly, it becomes possible to avoid a size increase of the inkjet recording apparatus 1 in the height direction.

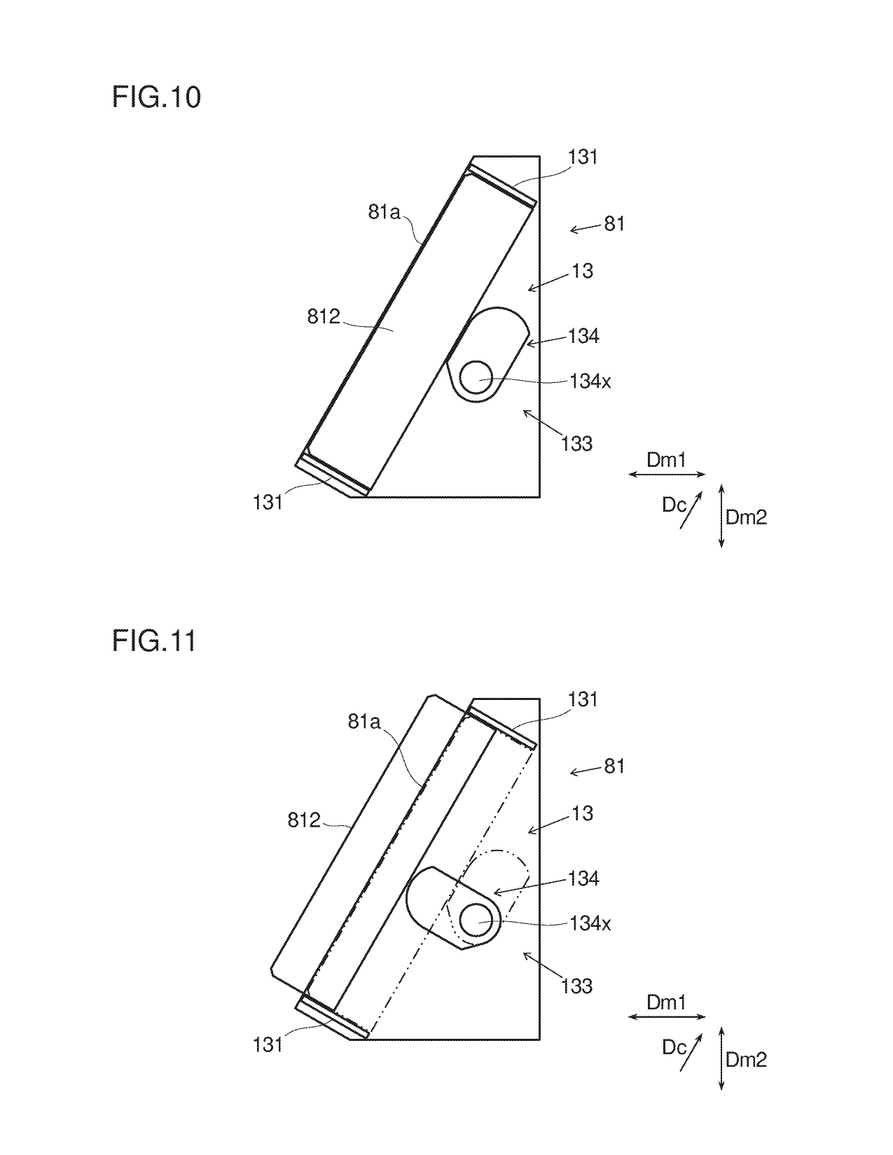

Relative to the maintenance surface 81a of the maintenance unit 81, the third movement mechanism 13 moves the guide members 812 in the normal direction of the maintenance surface 81a. FIGS. 10 and 11 are sectional side views of the maintenance unit 81 shown in FIG. 3, illustrating states where the guide members 812 are arranged at a housing position and at the protruding position, respectively. The third movement mechanism 13 includes two pairs of third guide rails 131 and a third drive part 133.

The two pairs of third guide rails 131 are provided inside the maintenance unit 81 so as to be adjacent to the maintenance surface 81a and on outer sides of both ends of the maintenance surface 81a in the sheet width direction. The two pairs of third guide rails 131 are adjacent to the pair of guide members 812. On outer sides of one and the other ends of each of the guide members 812 in the sheet conveyance direction Dc, a corresponding one of the pairs of third guide rails 131 is arranged opposite to the each of the guide members 812 in the sheet conveyance direction Dc. The third guide rails 131 extend along a direction toward or away from the maintenance surface 81a, which is the normal direction of the maintenance surface 81a.

Each of the guide members 812 is interposed between a corresponding one of the pairs of third guide rails 131 arranged opposite to each other in the sheet conveyance direction Dc. The guide members 812 are supported to the third guide rails 131 so as to be reciprocatable parallel to the normal direction of the maintenance surface 81a along the third guide rails 131.

The third drive part 133 includes a drive source (not shown) such as a motor and a drive mechanism including a group of gears and a cam member 134.

The cam member 134 is arranged inside the maintenance unit 81. Relative to the maintenance surface 81a, the cam member 134 is arranged on an opposite side to the guide members 812 via the guide members 812. The cam member 134 contacts outer surfaces of the guide members 812 from an opposite side to the maintenance surface 81a (an interior side of the maintenance unit 81).

The cam member 134 is connected to the drive source of the third drive part 133 and receives rotational power from the drive source. The cam member 134 rotates about an axis of a rotary shaft 134x extending in the sheet width direction. The cam member 134 includes a large diameter part and a small diameter part that vary in radial length from a rotational center axis, and thus when the cam member 134 rotates, there occurs a change in distance from the center axis to a contact point thereof with the capping section 813.

When the small diameter part of the cam member 134 is opposed to the guide members 812 as shown in FIG. 10, the guide members 812 are arranged at the housing position at which the guide members 812 are housed relative to the maintenance surface 81a into the maintenance unit 81. Further, when the cam member 134 rotates for a prescribed amount from a state shown in FIG. 10 so that the large diameter part of the cam member 134 is opposed to the guide members 812 as shown in FIG. 11, the guide members 812 move to protrude from the maintenance surface 81a in the normal direction and are arranged at the protruding position at which the guide members 812 protrude for a prescribed amount from the maintenance surface 81a.

As described above, upon the motor being driven, the third movement mechanism 13 moves the guide members 812 in the normal direction of the maintenance surface 81a along the third guide rails 131. Specifically, the cam member 134 rotates in contact with the guide members 812 so that the guide members 812 are selectively arranged either at the protruding position (see FIGS. 7 and 11) at which the guide members 812 protrude from the maintenance surface 81a or at the housing position (see FIGS. 6 and 10) at which the guide members 812 are housed in the maintenance unit 81.

According to the above-described configuration, the guide members 812 provided in the maintenance unit 81 protrude from the maintenance surface 81a in the normal direction toward the ink ejection surface 51a and contact the recording head group 51. Thus, via the guide members 812, the recording head group 51 and the maintenance unit 81 directly engage with each other, and an opposing distance between the ink ejection surface 51a and the maintenance surface 81a is determined. Accordingly, it becomes possible, during the maintenance process, to maintain constant the opposing distance between the ink ejection surface 51a of the recording head group 51 and the maintenance surface 81a of the maintenance unit 81.

Furthermore, the guide members 812 contact the positioning members 53 provided in the recording head group 51 and arranged opposite to the maintenance surface 81a. That is, via the positioning members 53 for performing positioning of the recording head group 51 with respect to the conveyance belt 411, the opposing distance between the ink ejection surface 51a and the maintenance surface 81a can be set using the guide members 812. Accordingly, the opposing distance between the ink ejection surface 51a and the maintenance surface 81a can be determined with high accuracy, and this makes it possible to favorably execute the maintenance process with respect to the ink ejection surface 51a.

In a case of performing a capping process with respect to the ink ejection surface 51a, as shown in FIGS. 6 and 10, the guide members 812 are arranged at the housing position by the third movement mechanism 13, and the recording head group 51 is caused to contact the guide members 812 (the maintenance unit 81) via the positioning members 53. In a state where the recording head group 51 is in contact with the guide members 812 being at the housing position, the capping section 813 is arranged at the mounting position at which the capping section 813 covers the ink ejection surface 51a.

According to the above-described configuration, in the case of performing the capping process with respect to the ink ejection surface 51a, an appropriate opposing distance between the ink ejection surface 51a and the maintenance surface 81a is determined. The recording head group 51 and the maintenance unit 81 directly engage with each other, so that it becomes possible to maintain the opposing distance constant, and thus the capping process with respect to the ink ejection surface 51a can be favorably executed.

In a case of performing the wiping process with respect to the ink ejection surface 51a, as shown in FIGS. 7 and 11, the guide members 812 are arranged at the protruding position by the third movement mechanism 13, and the recording head group 51 is caused to contact the guide members 812 (the maintenance unit 81) via the positioning members 53. In a state where the recording head group 51 is in contact with the guide members 812 being at the protruding position, the wiping section 814 is arranged at the start position for starting the wiping process, which is at a prescribed distance from the ink ejection surface 51a in the normal direction of the maintenance surface 81a and downstream of the ink ejection surface 51a in the sheet conveyance direction.

Further, the recording head group 51 is moved by the first movement mechanism 11, while the maintenance unit 81 is moved by the second movement mechanism 12, and thus the wiping section 814 performs the wiping process of contacting the ink ejection surface 51a and wiping off the ink therefrom. According to this configuration, in the case of performing the wiping process with respect to the ink ejection surface 51a, an appropriate opposing distance between the ink ejection surface 51a and the maintenance surface 81a is determined. The recording head group 51 and the maintenance unit 81 directly engage with each other, so that it becomes possible to maintain the opposing distance constant, and thus the wiping process with respect to the ink ejection surface 51a can be favorably executed.

Furthermore, the first movement direction Dm1 in which the recording head group 51 is moved by the first movement mechanism 11 is orthogonal to the second movement direction Dm2 in which the maintenance unit 81 is moved by the second movement mechanism 12. The ink ejection surface 51a and the maintenance surface 81a are inclined with respect to the first movement direction Dm1 and the second movement direction Dm2. Further, in the wiping process, the first movement mechanism 11 moves the recording head group 51 in a direction toward the maintenance unit 81, while the second movement mechanism 12 moves the maintenance unit 81 in a direction away from the recording head group 51.

Thus, the recording head group 51 and the maintenance unit 81 move from the start position for starting the wiping process shown in FIG. 7 to the end position for ending the wiping process shown in FIG. 9. In the sheet conveyance direction Dc, the wiping section 814 moves from the start position for starting the wiping process downstream of the ink ejection surface 51a to the end position for ending the wiping process upstream of the ink ejection surface 51a. According to this configuration, the wiping section 814 can favorably contact the ink ejection surface 51a inclined with respect to the horizontal direction and perform the wiping process with respect thereto. Thus, it becomes possible to effectively carry out the wiping process with respect to the inclined ink ejection surface 51a.

Respective operations of the first movement mechanism 11 and the second movement mechanism 12 are controlled by the control portion 7. The control portion 7 transmits to at least one of the first movement mechanism 11 and the second movement mechanism 12 a control signal for increasing a movement speed of the recording head group 51 to a speed equal to or higher than that of the maintenance unit 81.

According to the above-described configuration, the recording head group 51 is brought to a state of being constantly pressed against the maintenance unit 81. Thus, it is possible to suppress a phenomenon in which the recording head group 51 and the maintenance unit 81 unintentionally move away from each other. That is, it becomes possible to enhance an effect of, during the maintenance process, maintaining constant the opposing distance between the ink ejection surface 51a of the recording head group 51 and the maintenance surface 81a of the maintenance unit 81.

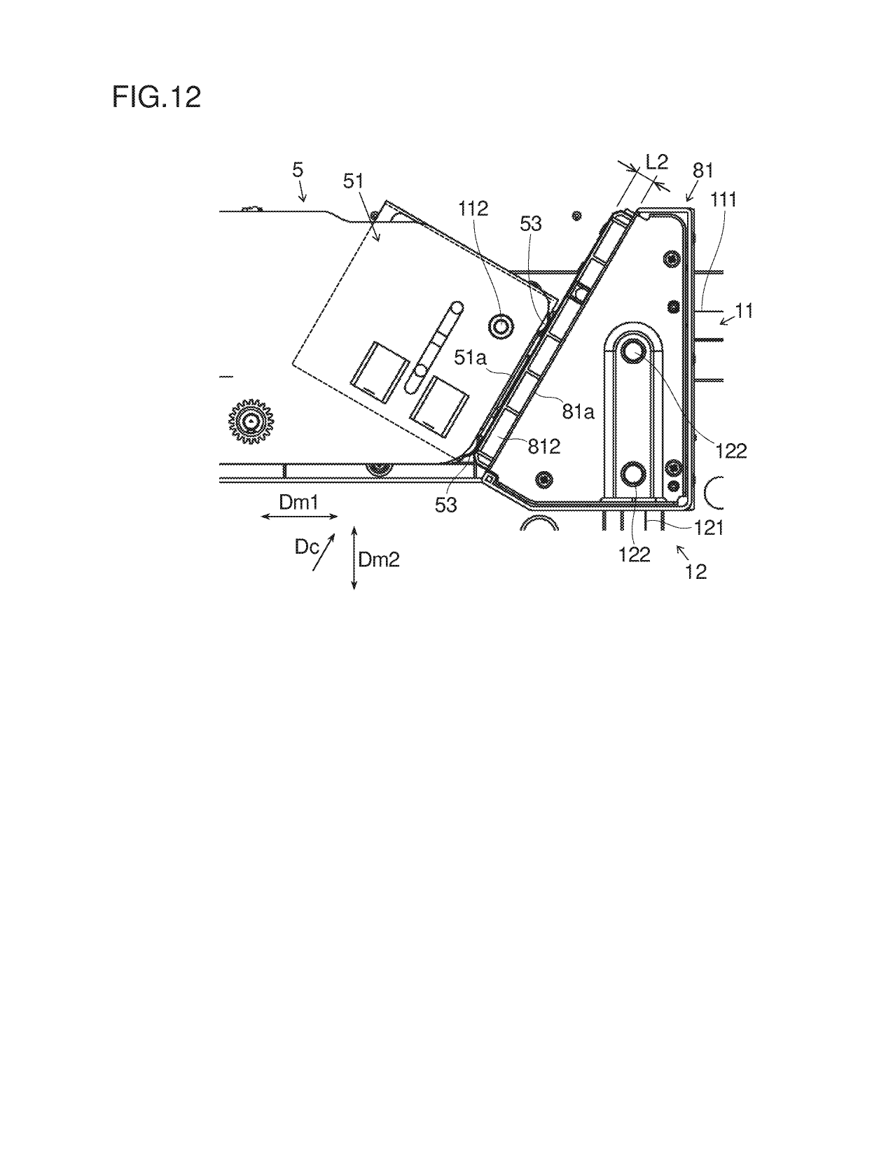

The protruding position of the guide members 812 includes a first protruding position and a second protruding position. As shown in FIGS. 7, 8, and 9, the first protruding position of the guide members 812 is a position for performing the wiping process with respect to the ink ejection surface 51a. As shown in FIG. 12, the second protruding position of the guide members 812 is a position at which the guide members 812 protrude for a length shorter than at the first protruding position.

FIG. 12 is a side view of the recording portion 5 shown in FIG. 2 and the maintenance unit 81, illustrating a state of flushing of the recording head group 51. Specifically, a protruding length L2 for which the guide members 812 protrude at the second protruding position shown in FIG. 12 is shorter than a protruding length L1 for which the guide members 812 protrude at the first protruding position shown in FIG. 7.

In a state where the recording head group 51 is in contact with the guide members 812 being at the second protruding position, the capping section 813 is at a prescribed distance from the ink ejection surface 51a in the normal direction of the maintenance surface 81a and is arranged opposite to the ink ejection surface 51a. Further, the recording head group 51 performs the flushing process in which, during the non-image recording period, the ink is ejected through the nozzles 511 in the ink ejection surface 51a. The ink ejected during the flushing process is discharged into the capping members 813c and is conveyed to the waste ink tank 83 by the suction pump 82.

According to the above-described configuration, in a case where the flushing (idle ejection) process of ejecting the ink is performed in the recording head group 51, an appropriate opposing distance between the ink ejection surface 51a and the maintenance surface 81a is determined. The recording head group 51 and the maintenance unit 81 directly engage with each other, so that it becomes possible to maintain the opposing distance constant, and thus the flushing process of the recording head group 51 can be favorably executed.

Furthermore, the ink ejection surface 51a is not brought to a fully capped state, and thus in a case of, for example, performing the flushing process between recording operations on successive sheets S in continuous recording, an amount of time required for the flushing process can be minimized. Thus, it becomes possible to perform recording on the sheet S in a reduced time while performing the maintenance process with respect to the recording head group 51.

What is claimed is:

1. An inkjet recording apparatus, comprising:
a conveyance portion that conveys a recording medium;
a recording head having an ink ejection surface in which a nozzle for ejecting ink onto the recording medium is open and that is arranged parallel and opposite to a conveyance surface of the conveyance portion;
a maintenance unit that performs a maintenance process with respect to the ink ejection surface of the recording head;
a first movement mechanism that moves the recording head so that the recording head is selectively arranged either at a recording position close to the conveyance portion or at a maintenance position distant from the recording position; and
a second movement mechanism that moves the maintenance unit so that the maintenance unit is selectively arranged either at an insertion position between the conveyance surface and the ink ejection surface or at a retracted position retracted from the insertion position,
wherein
the maintenance unit includes:
a maintenance surface that is arranged parallel and opposite to the ink ejection surface of the recording head and performs the maintenance process with respect to the ink ejection surface;
a guide member that is supported to the maintenance unit so as to be reciprocatable from the maintenance surface in a normal direction thereof toward and away from the ink ejection surface and contacts the recording head during the maintenance process; and
a third movement mechanism that moves the guide member in the normal direction of the maintenance surface so that the guide member is selectively arranged either at a protruding position at which the guide member protrudes from the maintenance surface or at a housing position at which the guide member is housed in the maintenance unit.

2. The inkjet recording apparatus according to claim 1, wherein
the recording head includes a positioning member that is provided outside an ejection region on the ink ejection surface and is arranged opposite to the maintenance surface of the maintenance unit, and
the guide member contacts the positioning member.

3. The inkjet recording apparatus according to claim 1, wherein
the maintenance unit includes, on the maintenance surface, a capping section for covering the ink ejection surface of the recording head, and
in a state where the recording head is in contact with the guide member being at the housing position, the capping section is mounted to the ink ejection surface.

4. The inkjet recording apparatus according to claim 1, wherein
the maintenance unit includes, on the maintenance surface, a wiping section that wipes off the ink from the ink ejection surface, and
in a state where the recording head is in contact with the guide member being at the protruding position, the wiping section performs a wiping process of contacting the ink ejection surface and wiping off the ink therefrom.

5. The inkjet recording apparatus according to claim 4, wherein
a first movement direction in which the recording head is moved by the first movement mechanism is orthogonal to a second movement direction in which the maintenance unit is moved by the second movement mechanism,
the ink ejection surface and the maintenance surface are inclined with respect to the first movement direction and the second movement direction, and
in the wiping process, the first movement mechanism moves the recording head in a direction toward the maintenance unit, while the second movement mechanism moves the maintenance unit in a direction away from the recording head.

6. The inkjet recording apparatus according to claim 5, further comprising:
a control portion that controls operations of the first movement mechanism and the second movement mechanism,
wherein the control portion transmits to at least one of the first movement mechanism and the second movement mechanism a control signal for increasing a movement speed of the recording head to a speed equal to or higher than that of the maintenance unit.

7. The inkjet recording apparatus according to claim 4, wherein
the protruding position of the guide member includes:
a first protruding position for performing the wiping process; and
a second protruding position at which the guide member protrudes for a length shorter than at the first protruding position, and
in a state where the recording head is in contact with the guide member being at the second protruding position, the recording head performs a flushing process in which, during a non-image recording period, the ink is ejected through the nozzle.
